(19) United States
(12) Patent Application Publication
(10) Pub. No.: US 2011/0088436 A1
(43) Pub. Date: Apr. 21, 2011

(54) SAFETY CLOSURE DEVICE FOR DRAWERS AND DOORS

(76) Inventor: Paolo Cioni, Ponsacco (IT)

(21) Appl. No.: 12/737,192

(22) PCT Filed: Apr. 15, 2009
(86) PCT No.: PCT/EP2009/054440

§ 371 Date: Dec. 16, 2010

(30) Foreign Application Priority Data
Aug. 29, 2008 (IT) MC2008A000156

(51) Int. Cl. E05B 65/46; E05C 1/14

(52) U.S. Cl. 70/85

(57) ABSTRACT

A safety closure device (100) for drawers or doors is disclosed, which comprises a lock device (7) designed to be fixed to a border (6) of a drawer or door for locking in closed position and an actuation mechanism (M) designed to be connected to a handle (1) and to the lock device (7), in order to unlock the lock device (7) by means of the handle (1). The actuation mechanism (M) comprises a body (2, 4) designed to be fixed in a hole (60) or the door (6) of the drawer, and a joint (3) mounted in the body (2, 4) in an articulated way. The joint (3) comprises a pin (30) to unlock the lock device (7) and a connection (31) fixed to the handle (1).

This patent application relates to a safety closure device for drawers and doors.

Although the description below makes specific reference to drawers, this invention also relates to cabinet doors.

The chests of drawers mounted, in particular, in means of transportation, such as boats, camper vans and similar vehicles, are impaired by accidental opening during the motion of the vehicle.

To solve such an inconvenience, each drawer is generally provided with an automatic safety closure device that keeps the drawer closed and allows for opening it only when the handle is actuated by the user.

The known safety devices are impaired by some inconveniences, especially due to the fact that they require a structural modification of the drawer and of the handle designed to actuate the safety closure device. Moreover, these safety closure devices are rather complicated, due to the presence of a large number of components that are bulky and difficult to mount.

The purpose of the present invention is to eliminate the drawbacks of the known technique, devising a safety closure device for drawers that is versatile and suitable for being applied in all types of drawer and handle that are commonly found on the market, without the need to modify the structure of the drawer and handle.

Another purpose of the present invention is to devise such a safety closure device for drawers that is inexpensive, not too bulky and simple to make and mount.

These purposes are achieved by the present invention, whose features are claimed in the independent claim 1.

Advantageous embodiments are disclosed in the dependent claims.

The safety closure device for drawers according to the invention comprises:
a lock device designed to be fixed to a door of the drawer to lock the drawer in closed position, and
an actuation mechanism designed to be connected to a handle and to the lock device, in order to unlock the lock device by means of a handle.

The actuation mechanism comprises a body designed to be fixed in a hole of the door of the drawer and a joint mounted in an articulated way in the body. The joint comprises a pin to unlock the lock device and a connection fixed to the handle.

The advantages of the safety closure device according to the invention are evident.

Advantageously, the connection of the joint consists in a threaded pin that is screwed into the standard threaded holes of the handles, without the need to modify the said handles.

The actuation mechanism is only composed of two elements: the body and the joint mounted in the body. Such an actuation mechanism is not too bulky and can be easily mounted in a hole of a door of the drawer.

The pin of the joint of the actuation mechanism directly actuates the closure device, without the need for the complicated bulky systems used in the known closure devices to return and transmit motion.

Additional characteristics of the invention will appear more evident from the following detailed description, which refers to merely illustrative, not limiting embodiments, illustrated in the enclosed drawings, wherein:

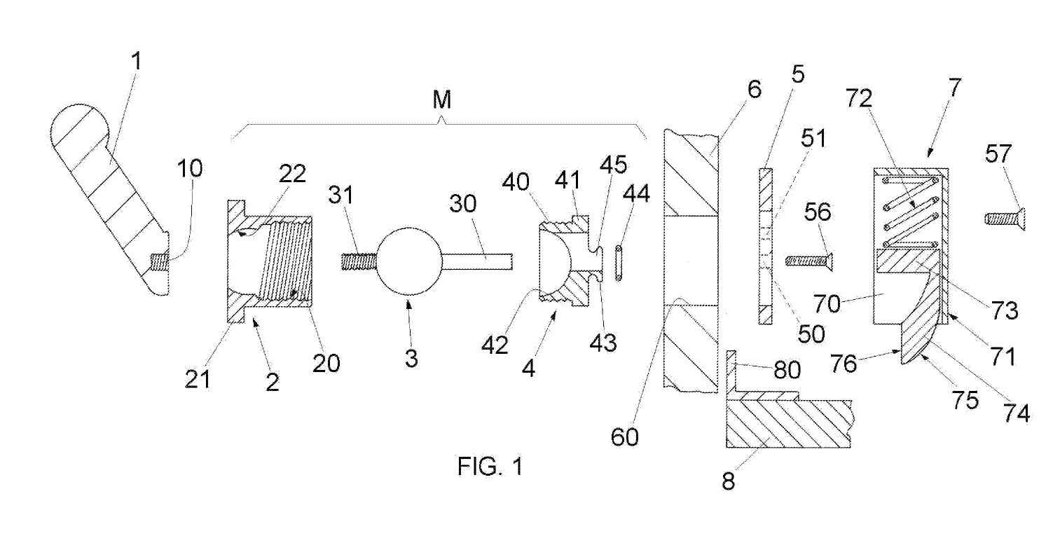

FIG. 1 is an exploded axial cross-sectional view of the safety closure device of the invention;

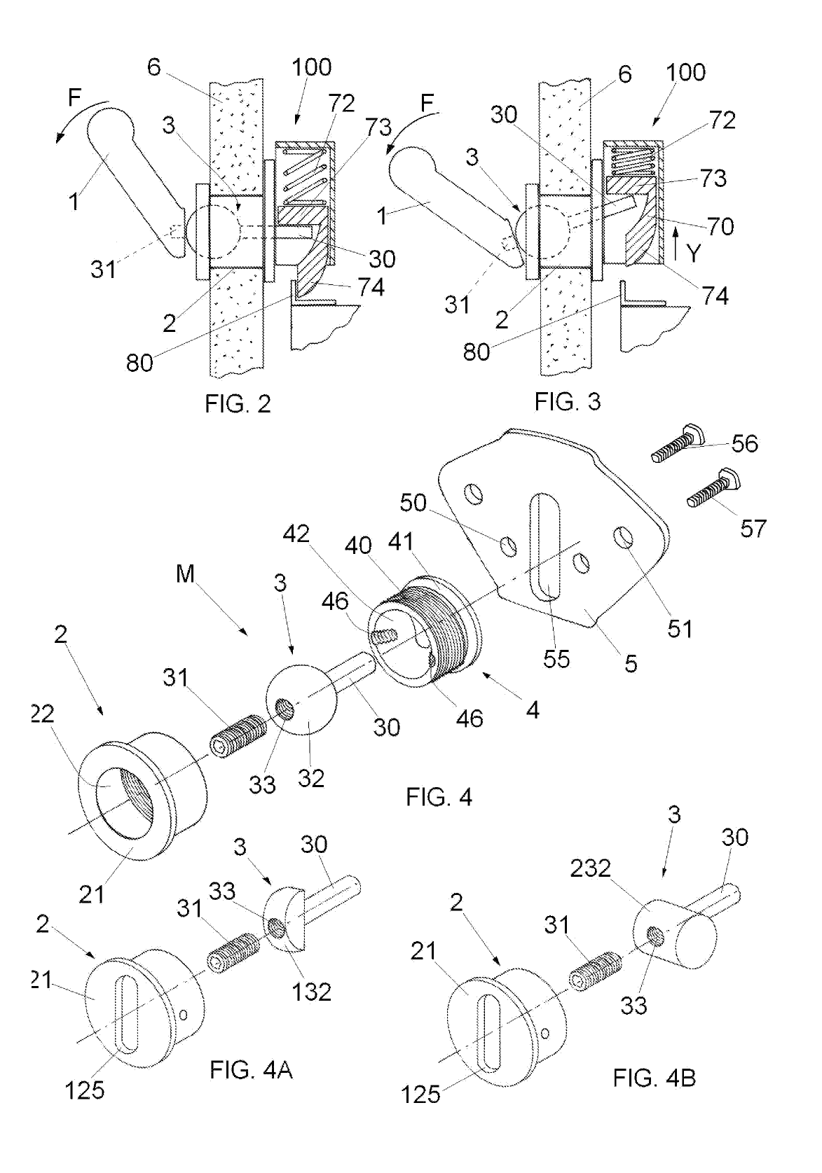

FIG. 2 is a diagrammatic view of the device of FIG. 1 assembled in closed position;

FIG. 3 is a diagrammatic view of the device of FIG. 1 assembled in open position;

FIG. 4 is an exploded perspective view of a first embodiment of the actuation mechanism of the safety closure device of FIG. 1, and of a fixing plate of such an actuation mechanism;

FIGS. 4A and 4B are two different versions of the joint of the actuation mechanism of FIG. 4;

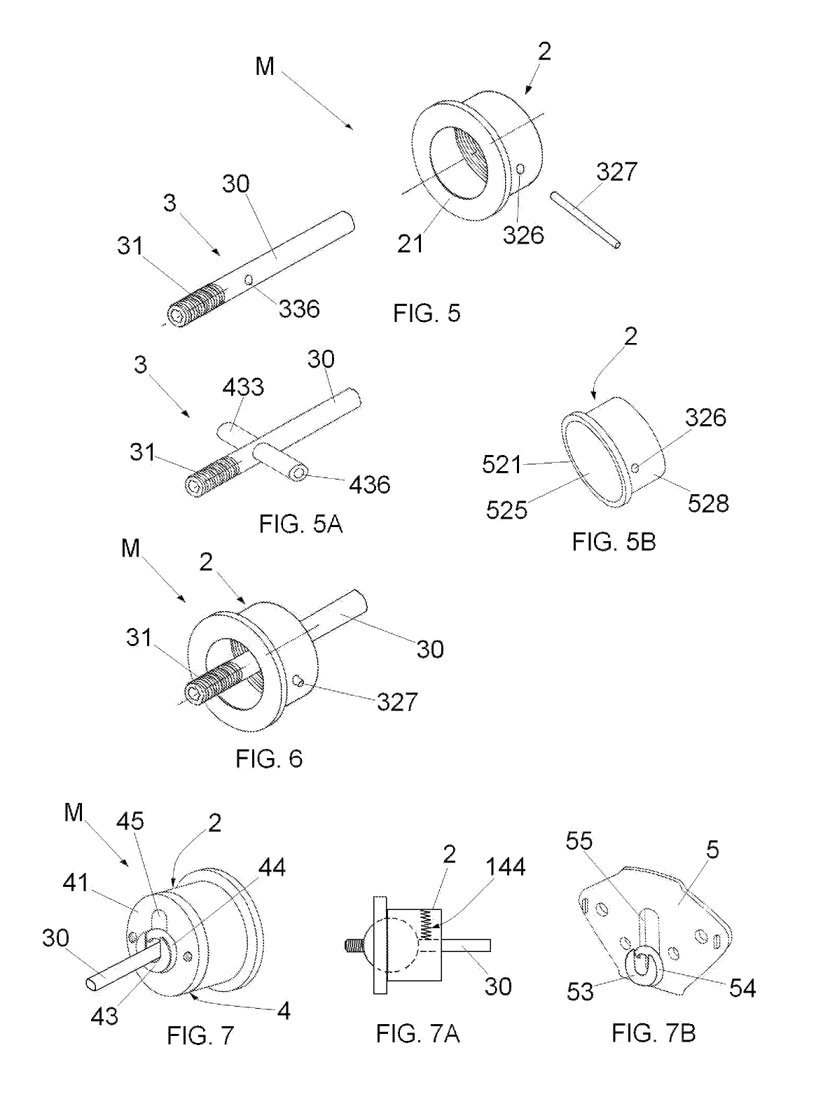

FIG. 5 is an exploded perspective view of a second embodiment of the actuation mechanism of the safety closure device;

FIGS. 5A and 5B are two different versions of the actuation mechanism of FIG. 5;

FIG. 6 is a perspective view of the actuation mechanism of FIG. 5 in assembled condition;

FIG. 7 is a perspective view of the actuation mechanism of FIG. 4 in assembled condition, seen from a different perspective from FIG. 4 to see a safety system;

FIG. 7A is a diagrammatic view of a different version of the safety system of FIG. 7;

FIG. 7B is a perspective view that illustrates a different version of the fixing plate of FIG. 4 that incorporates a safety system;

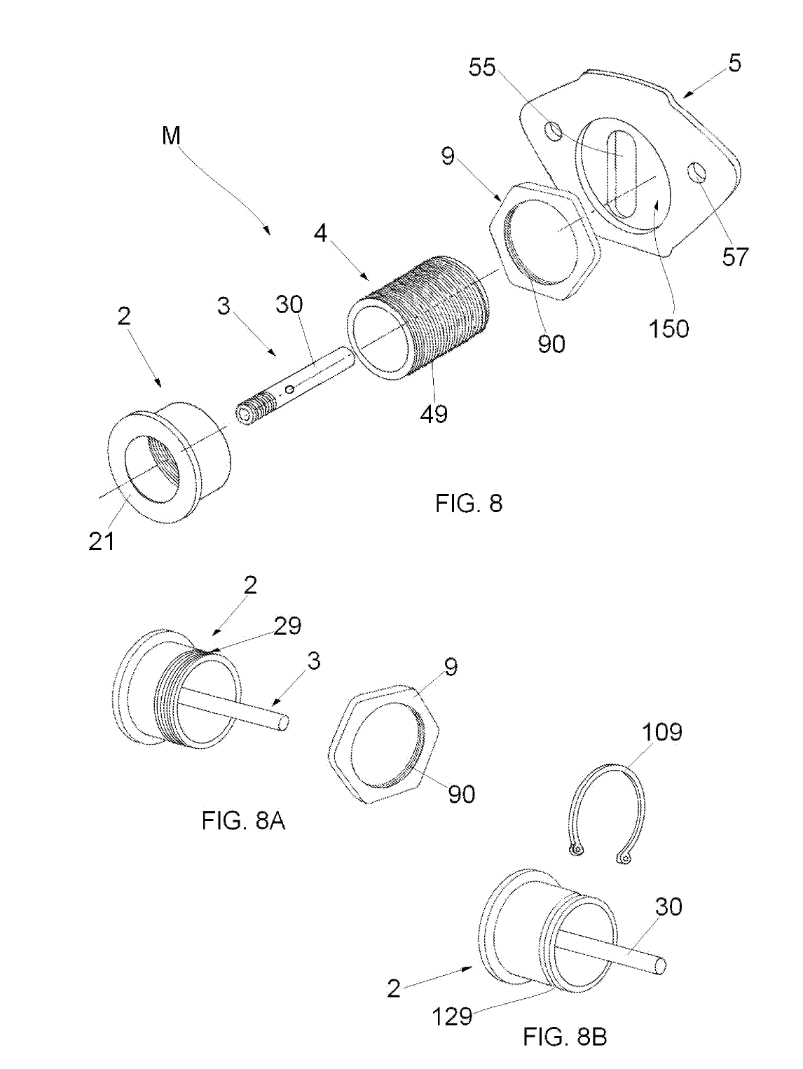

FIG. 8 is an exploded perspective view of a different version of the fixing system of the actuation mechanism; and

FIGS. 8A and 8B are two perspective views of two different versions of the fixing system of the actuation mechanism.

With reference to FIGS. 1, 2 and 3, a first embodiment of the safety closure device is described and identified with numeral (100).

The closure device (100) comprises:
a lock mechanism (7) designed to be fixed to a border (6) of a drawer or door to lock the drawer or door in closed position, and
an actuation mechanism (M) designed to be connected to a handle (1) and to the lock device (7) in order to unlock the lock device (7) by means of the handle (1).

The lock device (7) comprises a flange (70) in which a catch (71) pushed by a spring (72) is mounted with possibility of sliding. The catch (71) has a basically L-shaped shape and is provided with a wall (73) that supports one end of the spring (72) and a tooth (74) that protrudes from the flange (70) in lower position. The tooth (74) has a rounded entrance surface (75) that acts as cam and a straight exit surface (76) that acts as stop.

The frame (8) of the mobile chest of drawers is provided with a corresponding part (80) that protrudes upwards, being obtained for example from an L-shaped section. When the drawer is closed, the rounded surface (75) of the tooth comes in contact with the part (80) of the chest of drawers and acts as cam, lifting the catch (71) that compresses the spring (72). When the tooth (74) exceeds the part (80) of the chest of drawers, the spring (72) is discharged and the catch is released downwards. Consequently, (as shown in FIG. 2) the drawer (6) cannot be opened, since the flat stop surface (76) of the tooth is stopped against the part (80) of the chest of drawers.

The actuation mechanism (M) comprises a joint (3) provided with a pin (30) and a connection (31). The pin (30) is designed to be inserted into an opening of the flange (70) of the lock device in order to push the wall (73) of the catch against the action of the spring (72). The connection (31) is provided with external thread in order to be screwed into a threaded hole (10) of the handle. The joint (3) is mounted in an articulated way in a body composed, in the example of FIG. 1, of two bushes (2, 4) that are screwed one inside the other. Evidently, the body can also be made in one piece.

The body (2, 4) of the actuation mechanism (M) is inserted in a hole (60) of the door of the drawer and fixed to the door (6) by means of suitable fixing means (5) that, in the example of FIG. 1, provide for a plate (5) with threaded holes (50) to receive screws (56) that are screwed into corresponding holes (46) (FIG. 4) provided in a collar (41) of the internal bush (4) of the body.

The fixing plate (5) is provided with a slot hole (55) to receive the pin (30) and guide it during the actuation movement of the catch (71) of the closure device.

The fixing plate (5) is provided with holes (51) to receive screws (57) in order to fix the flange (70) of the lock device. The screws (57) are self-tapping screws and are screwed in the door (6) of the drawer, holding the fixing plate (5) firmly.

With reference to FIGS. 2 and 3, the manual actuation of the handle (1) in the direction of the arrow (F) causes the rotation of the joint (3) inside the body (2, 4). Consequently, the pin (30) pushes the wall (73) of the catch upwards against the action of the spring (72); the tooth (74) goes back in the flange (70) in the direction of the arrow (Y) and stops interfering with the part (80) of the frame of the chest of drawers; consequently, the drawer can be opened.

With reference to FIGS. 1 and 4, according to the first embodiment of the invention, the joint (3) is a ball joint and comprises a ball (32) that is contained in a spherical seat obtained in the body (2, 4). The ball (32) can be provided with a threaded hole (33) in which a pin (31) is screwed to act as threaded connection for the handle (1). Obviously, the pin (30) and connection (31) can be obtained in one piece that goes through the ball (32).

The bushes (2, 4) have a cylindrical body. The external bush (2) has an internal thread (20), and the internal bush (4) has an external thread (40). The external bush (2) has a collar (21) having a larger diameter than the hole (60) of the door of the drawer, in such a way to be stopped against the border of the said hole. The internal bush (4) has a collar (41) with the same diameter as the external bush (2) in such a way to be stopped against the ending border of the external bush (2).

In the example of FIG. 1, although the two bushes (2, 4) have a semi-spherical seat (22, 42), only one bush with a semi-spherical seat is sufficient.

In the following text the same numerals are used to indicate identical or corresponding elements with respect to the ones that have already been described, omitting their detailed description.

FIG. 4A shows a first version of the joint (3), in which a semi-cylindrical element (132) instead of a spherical element is used. In this case the external bush (2) has a slot hole (125) that must be arranged with the major axis orthogonal to the axis of rotation of the semi-cylinder (132), in such a way not to interfere with the movement of the connection (31).

FIG. 4B shows a second version of the joint (3), in which a cylindrical element (232) is used. Also in this case, the external bush (2) has a slot hole (125) that is arranged with major axis orthogonal to the axis of rotation of the cylinder (232).

FIGS. 5 and 6 show a second embodiment of the actuation mechanism (M), in which the joint (3) is only composed of the pin (30) with threaded connection (31). The pin (30) is hinged to the bush (2) by means of a plug (327) that transversally crosses the bush (2) and the pin (30). The pin (30) has a radial hole (336) and the bush (2) has two radial holes (326) arranged in diametrically opposite position to receive the pivoting plug (327).

FIG. 5A shows a different version of the joint (3) in which the pin (30) is shaped as a cross with a transversal arm (433) provided with through hole (436) to receive the plug (327).

FIG. 5B shows a different version of the bush (2) that is provided with a body (528) with elliptical cross-section. In this case the collar (521) of the bush has an elliptical shape and defines an elliptical hole (525) to guide the movement of the pin (30). Evidently, according to this embodiment, an elliptical hole (60) must be provided in the door (6) of the drawer (60) to receive the bush (528).

Going back to FIGS. 2 and 3, although the spring (72) of the lock device (7) is a safety element that prevents the drawer from opening accidentally, the actuation mechanism (M) can be provided with additional safety means to prevent the accidental opening of the drawer.

As shown in FIGS. 1 and 7, the back surface (41) of the internal bush (4) is provided with a U-shaped element (43) that defines a slot (45) in which the pin (30) of the joint can slide. The element (43) has a peripheral seat that receives an O-ring (44) made of elastic material. In view of the above, the pin (30) is received inside the O-ring (44). When the pin (30) moves upwards to unlock the lock mechanism (7), it must expand the O-ring (44) that acts as safety element, forcing the pin (30) to return to its original closure position.

As shown in FIG. 7A, in addition or replacement of the O-ring (44), a compression spring or elastic means (144) can be provided as safety element and arranged between the pin (30) and the internal wall of the external bush (2) or the internal bush (4).

As shown in FIG. 7B, also the fixing plate (5) can be provided with a safety system composed of a U-shaped element (53) arranged around the slot (55) and an O-ring (54) mounted on the element (53).

FIG. 8 shows a different system used to fix the actuation mechanism (M) to the door (6) of the drawer. In this case the internal bush (4) is composed of an externally threaded pin (49) that is screwed into the external bush (2) in such a way that part of the thread of the pin (49) remains uncovered to screw a ring nut (9) with internal thread (90), which is arranged beyond the door (6) of the drawer, acting as fixing element of the actuation mechanism (M).

Consequently, the fixing plate (5) is provided with a recessed seat (150) to receive the ring nut (9). In this case, since the holes (50) for the screws (56) shown in the version of FIG. 1 are not necessary, the slot (55) can be enlarged to eliminate tolerance problems during mounting.

FIG. 8A shows a different version of the fixing system, in which the external bush (2) is provided with an external thread (29) to screw the threaded ring nut.

FIG. 8B shows a second version of the fixing system, in which the external bush (2) is provided with an annular groove (129) to receive an E-ring (109) that acts as stop element.

Numerous variations and modifications can be made to the present embodiments of the invention by an expert of the field, while still falling within the scope of the invention as claimed in the enclosed claims.

1. Safety closure device (100) for drawers and doors comprising:
a lock device (7) designed to be fixed on the internal side of a border (6) of a drawer or door for locking in closed position, and
an actuation mechanism (M) designed to be connected to a handle (1) and to the lock deice (7) in order to unlock the lock device (7) by means of the handle (1), said actuation mechanism (M) comprising:
a body (2, 4) designed to be fixed in a hole (60) of the border (6) of the drawer or door, and
a joint (3) mounted in an articulated way in the body (2, 4); said joint (3) comprising:
a pin (30) designed to unlock the lock device (7), and
a connection (31) designed to be fixed to the handle (1), wherein the connection (31) of the joint is a threaded pin designed to be screwed into a threaded hole (10) of the handle (1).

2. Device (100) according to claim 1, wherein the joint (3) is a ball joint that comprises a ball (32).

3. Device (100) according to claim 1, wherein the joint (3) is a semi-cylindrical joint that comprises a semi-cylinder (132) that rotates around its axis.

4. Device (100) according to claim 1, wherein the joint (3) is a cylindrical joint that comprises a cylinder (232) that rotates around its axis.

5. Device (100) according to claim 1, wherein the body (2, 4) comprises an external bush (2) in which an internal bush (4) is arranged to contain the said joint (3).

6. Device (100) according to claim 1, wherein the pin (30) of the joint (3) is hinged inside the body (2) around a transversal axis.

7. Device (100) according to claim 6, wherein the pin (30) is provided with a radial through hole (336) in which a plug (327) fixed to the body (2) is arranged.

8. Device (100) according to claim 7, wherein the pin (30) is shaped as a cross with-transversal arm (433) provided with a hole (436) in which the plug (327) fixed to the body (2) is arranged.

9. Device (100) according to claim 6, wherein the said body (2) comprises a bush (2) in which the joint (3) is hinged.

10. Device (100) according to claim 1, wherein the back wall of the body (2, 4) is provided with a slot (45) partially defined by a U-shaped element (43) provided with an O-Ring (44) crossed by the said pin (30).

11. Device (100) according to claim 1, wherein elastic means or spring (144) are arranged between he said pin (30) and the body (2, 4).

12. Device (100) according to claim 1, wherein it comprises a fixing plate (5) to fix the said actuation mechanism (M) and/or the lock device (7) to the door (6) of the drawer.

13. Device (100) according to claim 12, wherein the back wall of the fixing plate (5) is provided with a slot (55) partially defined by a U-shaped element (43) provided with an O-Ring (54) crossed by the said pin (30).

14. Device (100) according to claim 1, wherein the body (2, 4) is provided
in the front with a collar with larger diameter (21) that is stopped against the border of the hole (60) of the door, and
in the back with engagement means (49, 29; 129) designed to receive a part (9; 109) with larger diameter that is topped against the border of the hole (60) of the door on the opposite side of the collar (21).
